(19) United States
(12) Patent Application Publication
(10) Pub. No.: US 2025/0236133 A1
(43) Pub. Date: Jul. 24, 2025

(54) SPOKE NIPPLE, IN PARTICULAR FOR A BICYCLE WHEEL

(71) Applicant: SAPIM, Wilrijk (BE)

(72) Inventor: Amaury DE CORDES, Wilrijk (BE)

(21) Appl. No.: 18/699,449

(22) PCT Filed: Oct. 11, 2022
(86) PCT No.: PCT/EP2022/078293

§ 371 Date: Apr. 8, 2024

(30) Foreign Application Priority Data
Oct. 11, 2021 (BE) 2021/5789

(51) Int. Cl. B60B 1/04

(52) U.S. Cl. CPC B60B 1/045; B60B 2360/104

(57) ABSTRACT

Spoke nipple for an at least partly muscle powered bicycle wheel, the spoke nipple being configured to connect a spoke to a rim of said wheel, wherein the spoke nipple comprises a spoke nipple head including an at least partly enlarged head portion configured to retain the spoke nipple in the rim.

### FIELD OF THE INVENTION

The present invention generally relates to a spoke nipple, in particular for a bicycle wheel, preferably for an at least partly muscle powered bicycle wheel.

### BACKGROUND OF THE INVENTION

It is generally known that in spoked wheels the hub of the wheel is connected to the rim of the wheel through a plurality of spokes. The spokes are connected to the rim of the wheel through spoke nipples. Said spoke nipples can include a threading configured to receive and grasp a corresponding spoke threading such that turning of the spoke with respect to the spoke nipple, or the other way around, can increase or decrease tension of the spoke between the hub and the rim of the wheel. Spoke nipples exist in a variety of sizes and materials, depending on the size and shape of the spokes, and on the balance which needs to be made between weight of the spoke nipple and the strength of the spoke nipple.

In high-performance wheels, rims can for example be made of carbon, which material can make a wheel relatively light-weight and relatively stiff. In such carbon rim wheels, it is common to insert a washer between the spoke nipple and the rim. The washer is configured to improve load distribution of the spoke nipple over the rim and can prevent fatigue of the spoke nipple. However, wheels in which washers need to be inserted between the spoke nipples and the rim cannot be mounted automatically by a machine but need to be mounted manually, which is a time consuming and cost intensive activity.

It is therefore an aim of the present invention to solve or at least alleviate one or more of the above-mentioned problems. In particular, the invention aims at providing a spoke nipple which can be mounted relatively easily and which can improve load distribution in a bicycle wheel.

### SUMMARY OF THE INVENTION

To this aim, according to a first aspect of the invention, there is provided a spoke nipple characterized by the features of claim 1. In particular, the spoke nipple is for use in an at least partly muscle powered bicycle wheel. The spoke nipple is configured to connect a spoke to a rim of said wheel. The spoke nipple comprises a spoke nipple head including an at least partly enlarged head portion configured to retain the spoke nipple in the rim. In an inventive way, a largest diameter of said spoke nipple head is larger than or substantially equal to 7 mm. The wording ‘substantially’ can refer to production tolerances, which may for example be +/−0.1 mm. As a result, a largest diameter of said spoke nipple head of for example 6.95 mm would be included in the claim wording, but not a largest diameter of for example 6.85 mm. Said relatively large diameter of the spoke nipple head can allow an improved load distribution over the rim of the wheel such that a use of a washer may be avoided.

In particular, it is preferred that the at least partly enlarged head portion is configured to distribute load over the rim of the wheel. In this way, the at least partly enlarged head portion has a combined function, in addition to the general function of retaining the spoke to the rim of the wheel, which can simplify the mounting of spokes to the rim of the wheel.

The at least partly enlarged head portion of the spoke nipple head may preferably be configured to be in direct contact with the rim of the wheel. Prior art spoke nipples having a largest diameter of the spoke nipple head which is smaller than substantially 7 mm generally require the use of a washer between the rim and the spoke nipple, which can complicate the mounting of the spokes to the rim of the wheel. By providing a spoke nipple having a spoke nipple head having a largest diameter larger than or substantially equal to 7 mm, spokes can be mounted via said spoke nipples without the use of washers, which can allow an automatized mounting and tensioning of spokes in a rim of a wheel.

It is further preferred that the at least partly enlarged head portion of the spoke nipple head comprises a substantially rounded portion. The rounded portion can then have a ball joint function with respect to the spoke. When lateral forces are applied on the spoke, the rounded portion of the enlarged head portion of the spoke nipple head can allow some movement of the spoke nipple head in the rim such that the spoke can remain substantially aligned with the spoke nipple. This can prevent damage to the spoke received in the spoke nipple.

The spoke nipple may preferably comprise an end portion extending beyond the at least partly enlarged head portion of the spoke nipple head. Such an end portion is part of the nipple head and is lying opposite a second end portion of the spoke nipple, which second end is configured to receive a spoke. A diameter of said end portion is preferably substantially smaller than a diameter of the at least partly enlarged head portion such that the at least partly enlarged head portion can be considered enlarged not only with respect to a spoke nipple body but also with respect to the end portion extending beyond the at least partly enlarged head portion. Such an end portion extending beyond the at least partly enlarged head portion of the spoke nipple head can allow mounting and tightening of the spoke to the rim from said head end portion, in particular from the end of the spoke nipple opposite the spoke receiving end, which can facilitate the mounting and tightening of the spoke to the rim of the wheel.

Said end portion extending beyond the at least partly enlarged head portion of the spoke nipple head can preferably have a substantially square cross-section. Such a shape of the head end portion can facilitate the tightening of the spoke nipples. It is still more preferred that the spoke receiving end has a substantially square cross-section, which can not only facilitate spoke mounting and tightening but can also help in keeping the nipple tightened to the rim. Both end portions of the spoke nipple can thus advantageously have a similar cross-sectional shape. Other cross-sectional shapes can be used as well.

An angle between said end portion and the at least partly enlarged head portion of the spoke nipple head can advantageously be larger than 90°, in particular larger than 105°. Such an angle can contribute to the solidity of the nipple and can provide a spoke nipple which is relatively easy to manufacture.

The spoke nipple advantageously be made of aluminium or brass. These materials can form a good combination between weight and strength of the nipple. Other suitable materials can be used as well, as is known to the person skilled in the art.

According to a further aspect of the invention, there is provided a wheel for an at least partly muscle driven bicycle having the features of claims 9-10. Such a wheel can provide one or more of the above-mentioned advantages.

### BRIEF DESCRIPTION OF THE DRAWINGS

FIG. 1 shows a perspective view of a preferred embodiment of a spoke nipple according to a first aspect of the present invention;

FIG. 2A shows a side view of the spoke nipple of FIG. 1;

FIG. 2B shows a cross-sectional view along the line K-K of the spoke nipple of FIG. 2A;

FIG. 3 shows a detail of a schematic cross-section of a wheel according to a second aspect of the invention.

### DETAILED DESCRIPTION OF EMBODIMENT(S)

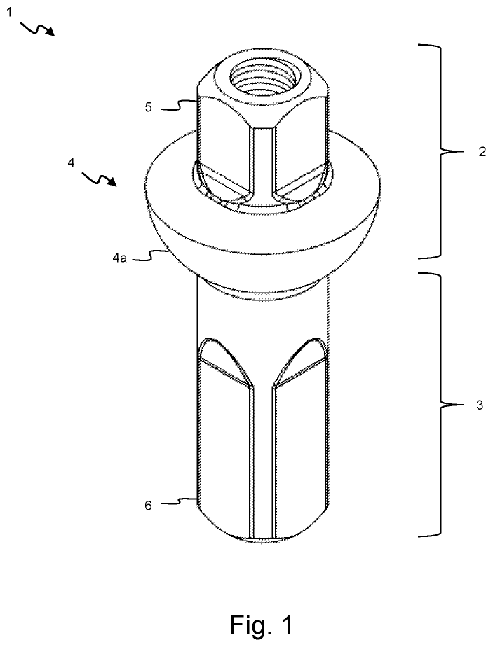

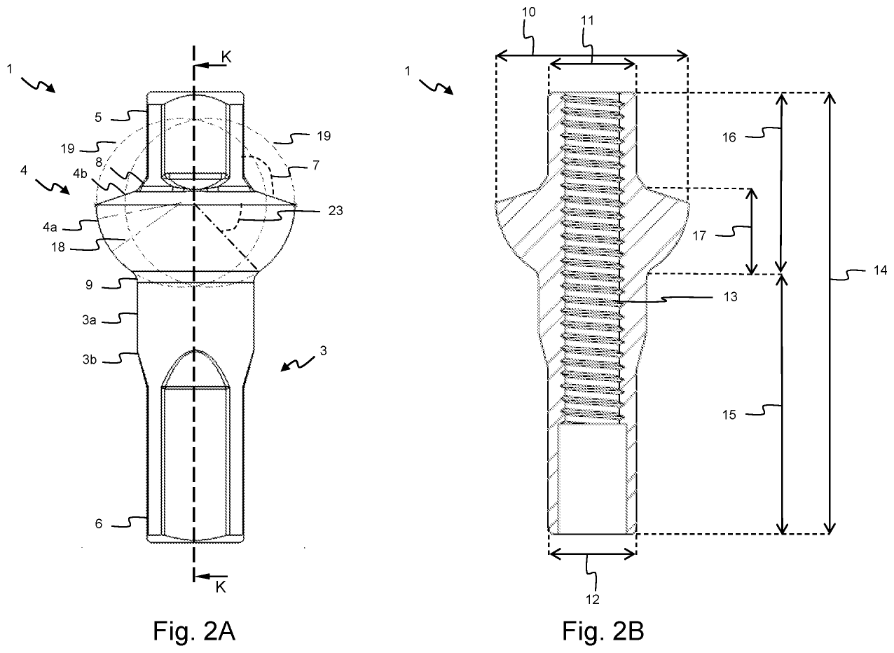

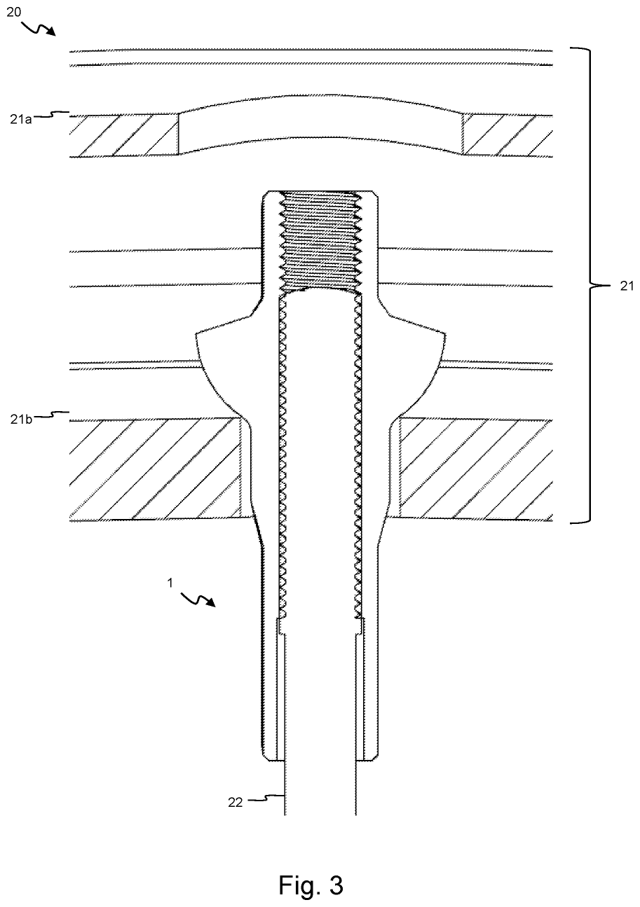

FIG. 1 shows a perspective view of a preferred embodiment of a spoke nipple 1 according to a first aspect of the present invention. The spoke nipple includes a spoke nipple head 2 and a spoke nipple body 3. The spoke nipple body 3 is configured to receive an end of a spoke. The spoke nipple body 3 is also configured to extend at least partly through a rim of a wheel, as shown in FIG. 3. The spoke nipple head 2 includes an at least partly enlarged head portion 4 configured to retain the spoke nipple 1 in a rim of a wheel. In other words, a largest diameter of the at least partly enlarged head portion 4 is larger than a diameter of the spoke nipple body 3. The at least partly enlarged head portion 4 of the spoke nipple 1 can comprise a substantially rounded portion 4a. Said rounded portion 4a can be in direct contact with the rim of the wheel and can function as a ball joint thanks to said rounded shape. The rounded portion 4a is said to be rounded because part of a lateral outer edge of said portion seen in a side view, as for example in FIG. 2, has a curved shape. At the same time, a cross-section of said rounded portion 4a along a plane which is transverse to a longitudinal direction of the spoke nipple 1 also has a rounded shape, in particular a substantially circular, elliptical or oval shape. The spoke nipple 1 can further comprise an end portion 5 extending beyond the at least partly enlarged head portion 4a of the spoke nipple head 2. Said end portion 5 can preferably have a substantially square cross-section and preferably has a diameter which is smaller than a diameter of the at least partly enlarged head portion 4, such that the at least partly enlarged head portion 4 can also be considered enlarged with respect to said end portion 5. Corners of said end portion 5 may be rounded-off or bevelled but the overall cross-sectional shape can remain substantially square. Opposite said head end portion 5, the spoke nipple 1, in particular the spoke nipple body 3, can include a second end 6 configured to receive a spoke. Said spoke receiving second end 6 can also have a substantially square cross-section. Said spoke receiving second end 6 is configured to extend through a rim of a wheel.

FIG. 2A shows a side view of the spoke nipple of FIG. 1 and FIG. 2B shows a cross-sectional view along the line K-K of the spoke nipple of FIG. 2A. The at least partly enlarged head portion 4 can preferably include a rounded portion 4a, next to a second portion 4b connecting the rounded portion 4a to the end portion 5 of the spoke nipple head 2. The rounded portion 4a can for example have a radius of curvature of more or less R=3 mm or more, for example a radius of curvature included between more or less R=3 mm and R=6 mm. A radius of curvature 18 may be defined as a radius of an osculating circle 19 approximating the curve defined by the rounded portion, as indicated by a dashed line in FIG. 2A. The rounded portion 4a may extend over an angle 23 which is smaller than 90°, preferably smaller than 50°, more preferably smaller than 40°, more preferably an angle included in a range between more or less 30° to more or less 40°, for example over an angle of substantially 35°. The second portion 4b connecting the rounded portion 4a to the end portion 5 of the spoke nipple head 2 may substantially have the shape of a truncated cone, resulting in a substantially straight edge when seen from a side view. An angle 7 between the end portion 5 and the at least partly enlarged head portion 4 of the spoke nipple head 2, and in particular the second portion 4b of the at least partly enlarged head portion 4, can preferably be larger than 90°. The connection between the end portion 5 and the second portion of the at least partly enlarged head portion 4 may include a bevel 8 having an angle with the end portion 5 which is still larger than the angle 7. Such a bevel 8 can reinforce the strength of the spoke nipple 1, in particular of the spoke nipple head 2. The spoke nipple 1 may further include a rounded connection portion 9 between the at least partly enlarged head portion 4 of the spoke nipple head 2 and the spoke nipple body 3, again to reinforce the strength of the nipple 1 by avoiding sharp or cornered portions. The spoke nipple body 3 may include a support portion 3a which may have a substantially circular cross-section and which may be slightly larger in diameter than the rest of the spoke nipple body 3 towards the spoke receiving second end portion 6. The transition between said support portion 3a and the remaining portion of the spoke nipple body 3 may include a bevel 3b, which may form an angle of more or less 15° to more or less 18° with a longitudinal axis of the spoke nipple 1. As indicated in FIG. 2B, a largest diameter 10 of said spoke nipple head 2, in particular of the enlarged head portion 4, is larger than or substantially equal to 7 mm. More preferably, said largest diameter 10 of said spoke nipple head 2, in particular of the enlarged head portion 4, may be included in a range of substantially 7 mm to substantially 12 mm. An external diameter or length 11 of a side of the substantially square head end portion 5 is preferably the same as an external diameter or length 12 of a side of the substantially square spoke receiving second end portion 6 and may for example be comprised in a range of more or less 3 mm to 3.5 mm, for example be 3.2 mm or 3.4 mm. A total height 14 of the spoke nipple 1 may be comprised between 10 mm and 20 mm, preferably between 13 mm and 17 mm, for example being around more or less 16 mm. A ratio of the height 15 of the spoke nipple body 3 to the height 16 of the spoke nipple head 2 may for example be comprised between 1.3 and 1.6, for example around 1.4. As an example, a height 15 of the spoke nipple body 3 may be more or less 9.5 mm and a height 16 of the spoke nipple head 2 more or less 6.5 mm. The enlarged head portion 4 of the spoke nipple head 2 may for example have a height 17 included in a range of substantially 2 mm to substantially 5 mm, preferably of more or less 3 mm. The spoke nipple 1 can include a spoke receiving cavity extending through substantially the entire spoke nipple. The spoke nipple 1, in particular said spoke receiving cavity, can further include an inner threading 13 configured to receive a corresponding screw thread of a spoke, which inner threading may extend through the support portion 3a of the spoke nipple body 3, through the at least partly enlarged head portion 4 of the spoke nipple head 2 and through the end portion 5, and which may have a diameter between for example 1.9 mm and 2 mm, for example of substantially 1.95 mm. A spoke receiving second end 6 of the spoke nipple body 2 may be free of such an inner threading. Other inner arrangements of the spoke nipple 1 are possible depending on the spokes the nipple is to receive.

FIG. 3 shows a detail of a schematic cross-section of a wheel 20 according to a second aspect of the invention. The wheel 20 is a wheel for an at least partly muscle driven bicycle. The wheel 20 comprises a rim 21 and a plurality of spokes 22, the spokes 22 being configured to extend between the central hub of the wheel (not shown) and the rim 21. The rim can preferably be made of carbon. A plurality of spoke nipples 1, which can for example be made of aluminium or brass, are configured to receive the plurality of spokes 22 and to connect the spoke 22 to the rim 21 of said wheel 20. The rim 21 can include an outer rim bed 21a configured to receive and hold a tyre tube and an inner rim support 21b, also called a nipple bed, through which the spoke nipple 1 can extend inwardly, in particular towards the hub of the wheel, to hold the spoke 22. The at least partly enlarged head portion 4 of the nipple head 2 is configured to retain the spoke nipple 1 in the rim 21. Due to said novel largest diameter of at least substantially 7 mm of the spoke nipple head 2, the head, and in particular the at least partly enlarged head portion 4, and more in particular the rounded portion 4a of said at least partly enlarged head portion 4 of the spoke nipple head 2, can be in direct contact with the rim 21, i.e. with an inner surface of the inner rim support 21b, without the need for any washer between said spoke nipple head 2 and said rim 21, in particular said inner surface of the inner rim support 21b. Mounting and tightening a spoke 22 to the spoke nipple 1 can be done from either ends 5, 6 of the spoke nipple 1 thanks to the head end portion 5 extending beyond the at least partly enlarged head portion 4. Due to said novel largest diameter of at least substantially 7 mm of the spoke nipple head 2, the at least partly enlarged head portion 4 can be configured to distribute load over the rim 21 of the wheel 20 without the need for support of a washer, which is commonly used in carbon rims. Without the need for a washer, the mounting of the spokes 22 to the rim 21 of the wheel 20 via the spoke nipples 1 can be facilitated and automated, which can reduce mounting time and costs.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A spoke nipple for an at least partly muscle powered bicycle wheel, the spoke nipple being configured to connect a spoke to a rim of said wheel, wherein the spoke nipple comprises:
a spoke nipple body configured to receive an end of said spoke, and
a spoke nipple head including an at least partly enlarged head portion configured to retain the spoke nipple in the rim,
wherein a largest diameter of said spoke nipple head is larger than or substantially equal to 7 mm.

2. The spoke nipple according to claim 1, wherein the at least partly enlarged head portion is configured to distribute load over the rim of the wheel.

3. The spoke nipple according to claim 1, wherein the at least partly enlarged head portion of the spoke nipple head is configured to be in direct contact with the rim of the wheel.

4. The spoke nipple according to claim 1, wherein the at least partly enlarged head portion comprises a substantially rounded portion.

5. The spoke nipple according to claim 4, wherein a radius of curvature of said rounded portion is comprised substantially between 3 mm to 6 mm.

6. The spoke nipple according to claim 1, wherein a height of said at least partly enlarged head portion is smaller than substantially 5 mm.

7. The spoke nipple according to claim 1, wherein the spoke nipple comprises an end portion extending beyond the at least partly enlarged head portion of the spoke nipple head.

8. The spoke nipple according to claim 7, wherein said end portion has a substantially square cross-section.

9. The spoke nipple according to claim 7, wherein an angle between the end portion and the at least partly enlarged head portion is larger than 90°.

10. The spoke nipple according to claim 1, wherein the spoke nipple is made of aluminium or brass.

11. A wheel for an at least partly muscle driven bicycle comprising a rim, a plurality of spokes and a plurality of corresponding spoke nipples configured to connect said plurality of spokes to said rim, wherein at least one of said plurality of spoke nipples is said spoke nipple according to claim 1.

12. The wheel according to claim 11, wherein the rim is made of carbon.

13. The spoke nipple according to claim 6, wherein a height of said at least partly enlarged head portion is smaller than substantially 2 mm.

14. The wheel as claimed in claim 11, wherein all of said plurality of said spoke nipples of the wheel are said spoke nipples.
